(19) United States
(12) Patent Application Publication
(10) Pub. No.: US 2016/0081255 A1
(43) Pub. Date: Mar. 24, 2016

(54) EXCAVATING TOOL

(71) Applicant: ANTONIO E. CACELA, HOLDEN, MA (US)

(72) Inventor: ANTONIO E. CACELA, HOLDEN, MA (US)

(21) Appl. No.: 14/887,119

(22) Filed: Oct. 19, 2015

Related U.S. Application Data
(63) Continuation of application No. 13/898,466, filed on May 21, 2013, now abandoned.
Application No. 13/898,466 is a continuation-in-part of application No. 13/898,476, filed on May 21, 2013, now abandoned.
(60) Provisional application No. 61/649,340, filed on May 20, 2012.

(51) Int. Cl. A01B 1/12; A01B 1/08

(52) U.S. Cl. CPC A01B 1/12; A01B 1/08

(57) ABSTRACT

A hoe-like excavation tool having an elongated handle, and a hoe plate mounted to one end of the handle, perpendicular to the handle and offset from the axis of the handle. The plate has a sharp working edge, and a plurality of teeth extending outward from the edge.

### CROSS-REFERENCE TO RELATED APPLICATIONS

This application claims the benefit under 35 U.S.C. §119(e) and §120 of U.S. Provisional Application No. 61/649,340 filed May 20, 2012, the entire contents of which is hereby incorporated by reference, application Ser. No. 13/898,466, filed May 21, 2013, and application Ser. No. 13/898,476, filed May 21, 2013.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves a hand tool for excavation.

### BACKGROUND OF THE INVENTION

I have been using tools most of my life, having grown up on a farm and using a variety of tools as a part of our daily routine.

More recently, I have established and run (hands-on involvement) a hardscaping construction company.

More than ten years ago, I purchased a couple of hoes at a regional hardware store (around $70 apiece) to supplement a couple of others which we used on just about all aspects of our work—excavating and site prep, as well as cleaning-up hard concrete cream from form boards. Although we use hydraulic equipment, there are instances in which machinery cannot be used, either due to physical limitations where access is not an option, or when the final excavation involves digging around utility lines and must be performed manually.

From actual first-hand field experience, these tools were not adequate for the job, especially here in the New England rocky soil. For instance, the blades are weak and bend backward out of form during moderate working load conditions and often had to be righted before proceeding again.

The eye ring, where the handle connects to the blade, is shallow, thereby providing inadequate grip of the blade unit. This condition creates a high stress point, resulting in the handle frequently loosening up due to wood fiber failure. Often, the handle broke there, usually at the most inopportune time.

With one particular hoe, over the last twelve years, perhaps because we used it more often, the thin steel blade (same as the others) cracked at least five or six times and one corner of the blade broke off completely. In all instances, I welded the blade back into working condition

We also use other tools from picks to mattocks to pry-bars, and rakes, etc. These are task specific, for work such as prying out and lifting larger rocks or cutting roots during site prep. However, they are not efficient for regular work flow and would be too heavy for sustained work, even in the hands of the strongest of laborers.

Prior systems for excavating hard-packed, stony, and root-filled soil, or hard packed snow, have proved to be inefficient, difficult to use, and prone to failure.

These and other difficulties experienced with the prior art devices have been obviated in a novel manner by the present invention.

It is, therefore, an outstanding object of some embodiments of the present invention to provide a hand tool for excavation, that overcomes the shortcomings of prior devices.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a hoe-like excavation tool having an elongated handle, and a hoe plate mounted to one end of the handle, perpendicular to the handle and extending outward from the axis of the handle. The plate has a castellated working edge, comprising a plurality of teeth extending outward from the edge, and cutting edges between the teeth. The tool also has cutter plate mounted to one end of the handle, perpendicular to the handle and extending outward from the axis of the handle, opposed to the hoe plate.

### BRIEF DESCRIPTION OF THE DRAWINGS

The character of the invention, however, may best be understood by reference to one of its structural forms, as illustrated by the accompanying drawings, in which:

FIG. 1 is a perspective view of an tool embodying the principles of the present invention, as it is employed by a user.

FIG. 2 is shows a plan view, looking down the handle, of a first embodiment including some of the principles of the present invention.

FIG. 3 shows a right side view of the lower portion of the first embodiment, shown in FIG. 2. The left side view is the mirror image of this view.

FIG. 4 shows a front view of the lower portion of the first embodiment, shown in FIG. 2.

FIG. 5 shows a back view of the lower portion of the first embodiment, shown in FIG. 2.

FIG. 6 shows a bottom view of the lower portion of the first embodiment, shown in FIG. 2.

FIG. 7 shows a full-length front view of the first embodiment, shown in FIG. 2.

FIG. 8 shows a full-length right side view of the first embodiment, shown in FIG. 2. The left side view is the mirror image of this view.

FIG. 9 shows a full-length back view of the first embodiment, shown in FIG. 2.

FIG. 10 shows a plan view, looking down the handle, of a second embodiment of the present invention.

FIG. 11 shows a right side view of the lower portion of the second embodiment, shown in FIG. 10. The left side view is the mirror image of this view.

FIG. 12 shows a front view of the lower portion of the second embodiment, shown in FIG. 10.

FIG. 13 shows a back view of the lower portion of the second embodiment, shown in FIG. 10.

FIG. 14 shows a bottom view of the second embodiment, shown in FIG. 10.

FIG. 15 shows a full-length front view of the second embodiment, shown in FIG. 10.

FIG. 16 shows a full-length right side view of the second embodiment, shown in FIG. 10. The left side view is the mirror image of this view.

FIG. 17 shows a full-length back view of the second embodiment, shown in FIG. 10.

FIG. 18 shows a perspective view of a small portion of the hoe plate, including two teeth and the blade edge between the two teeth and set back from the forward edge of the two teeth.

FIG. 19 shows a front elevation view of the hoe plate portion shown in FIG. 18, and showing the blade approaching a typical root found in soil.

FIG. 20 shows a front elevation view of the hoe plate portion having cut through the root.

FIG. 21 shows a right elevation view, in section taken along line 21-21 of FIG. 20, showing the root severed by the blade.

FIG. 22 shows the manner in which the adjacent teeth protect the blade from large stones which are the primary mechanism by which the blade is dulled.

FIG. 23 shows the manner in which the adjacent teeth allow small stones to approach the blade.

### DETAILED DESCRIPTION OF THE INVENTION

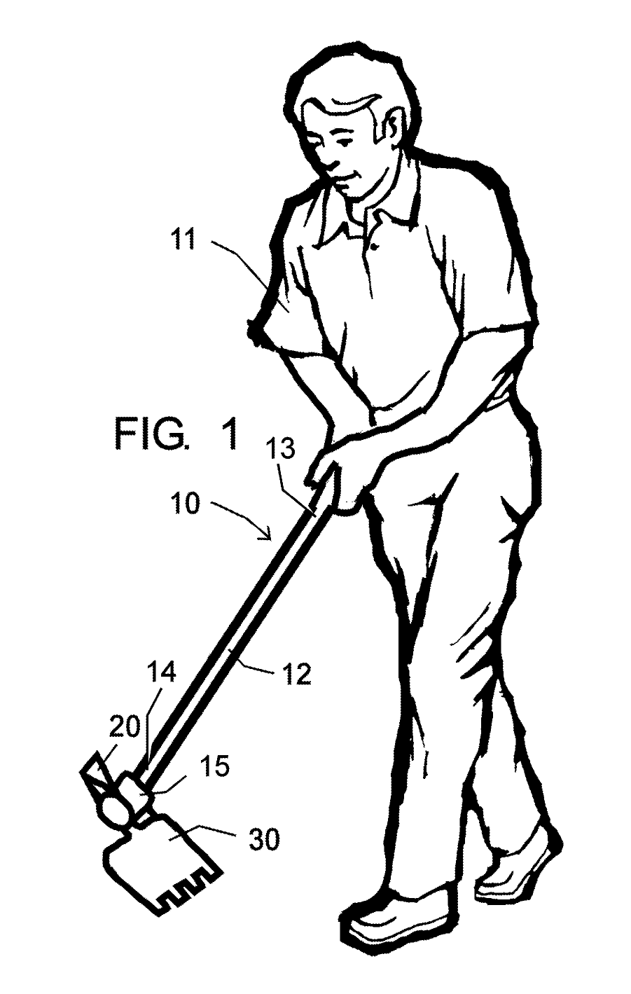

Referring first to FIG. 1 in which the general principles of the present invention are shown, FIG. 1 shows the manner in which the user 11 uses the hoe-like tool designated generally by the 10. The tool 10 includes an elongated handle 12 having a first end 13 which is held by the user 11, and a second end 14. A collar 15 is mounted on the second end 14 of the handle 12. Attached to one side of the collar 15 is a hoe plate 30, perpendicular to the handle and extending outward from the axis of the handle. The plate 30 has a castellated working edge 35, comprising a plurality of teeth 36 extending outward from the edge, and cutting edges or blades 37 between the teeth, and set back from the outer edge of the teeth 36. The tool 12 also has cutter plate 20 mounted to the collar 15, perpendicular to the handle, extending outward from the axis of the handle 12, and opposed to the hoe plate 30.

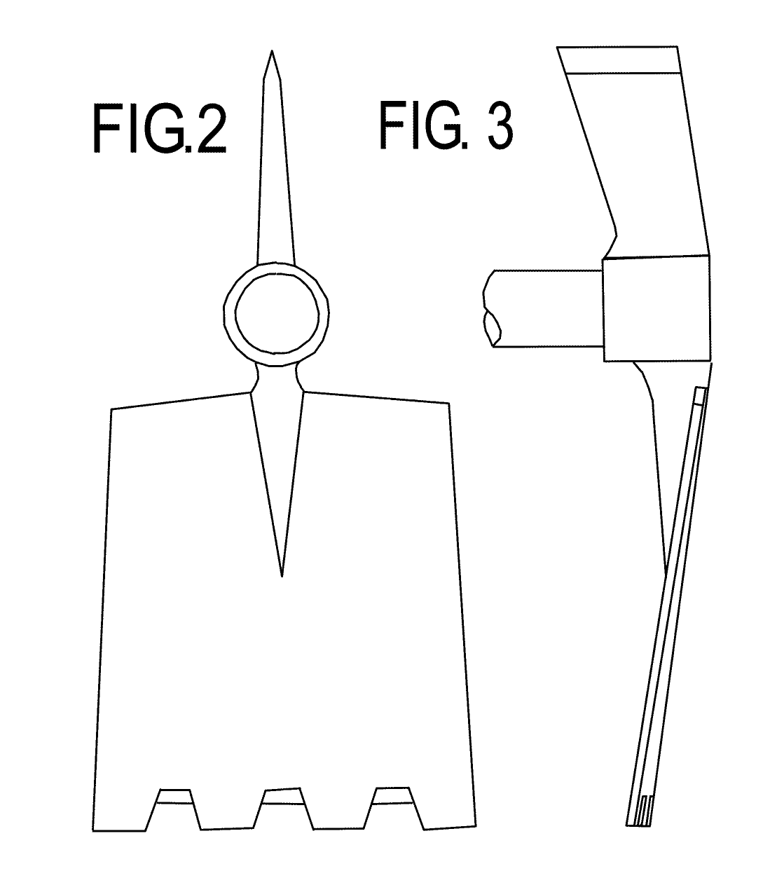

FIG. 2 is shows a plan view, looking down the handle, of a first embodiment including some of the principles of the present invention.

FIG. 3 shows a right side view of the lower portion of the first embodiment, shown in FIG. 2. The left side view is the mirror image of this view.

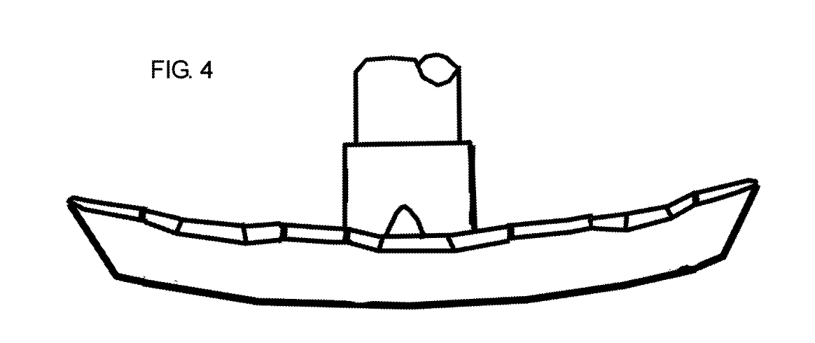

FIG. 4 shows a front view of the lower portion of the first embodiment, shown in FIG. 2.

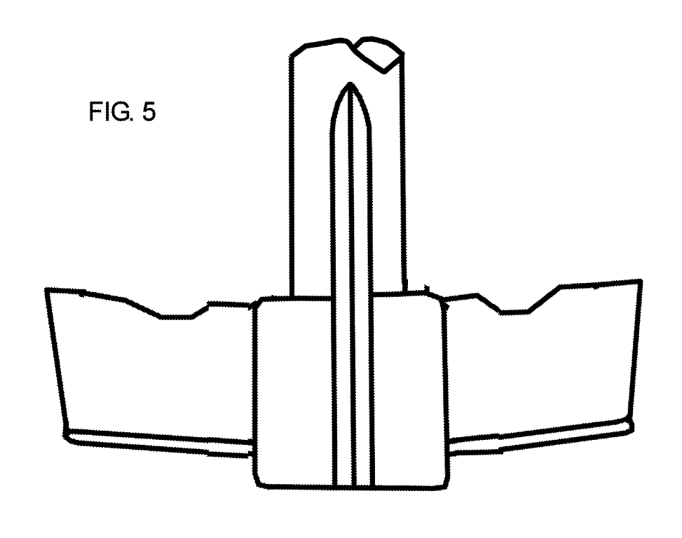

FIG. 5 shows a back view of the lower portion of the first embodiment, shown in FIG. 2.

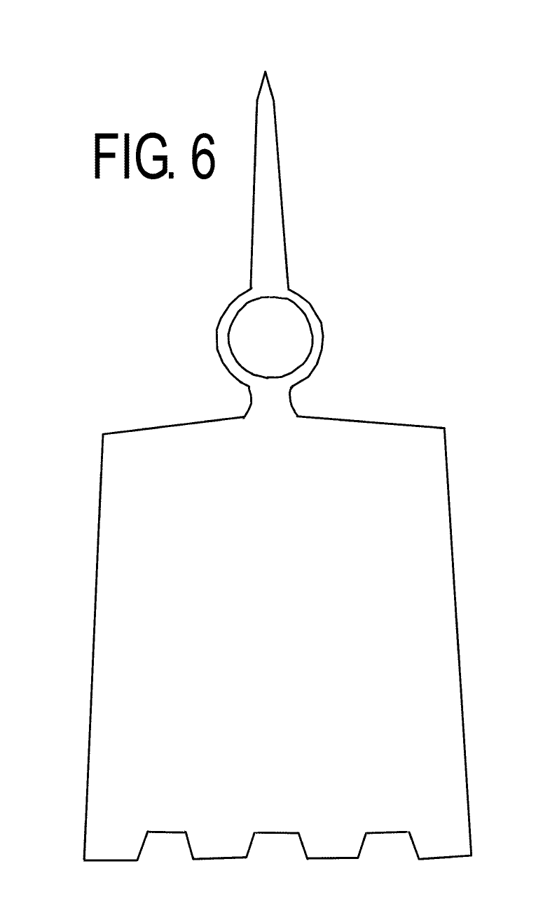

FIG. 6 shows a bottom view of the lower portion of the first embodiment, shown in FIG. 2.

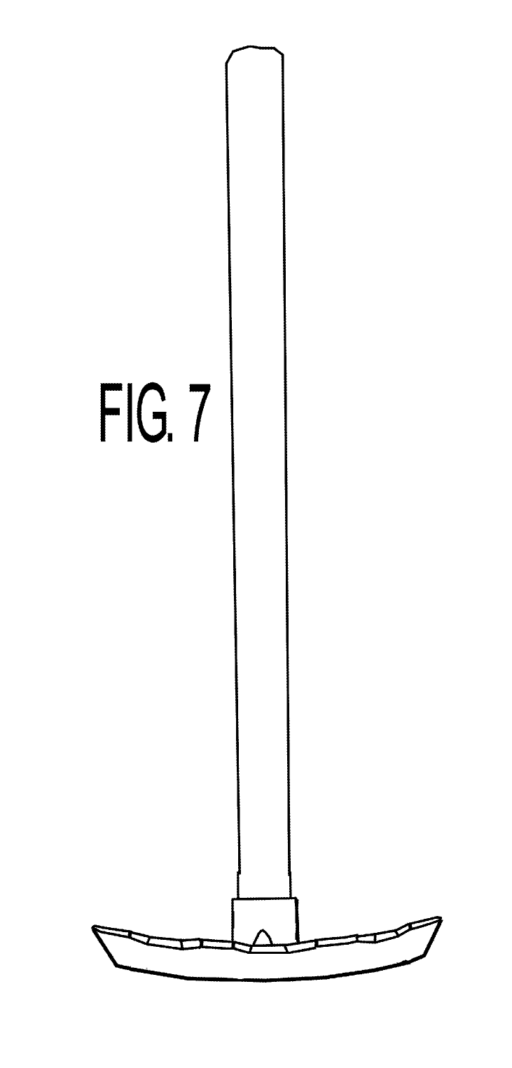

FIG. 7 shows a full-length front view of the first embodiment, shown in FIG. 2.

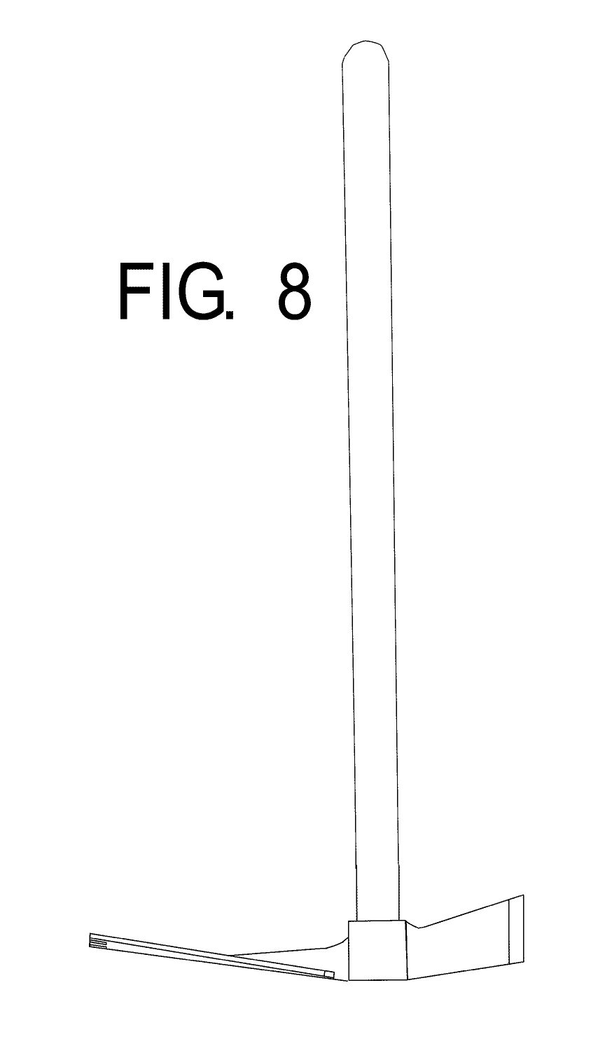

FIG. 8 shows a full-length right side view of the first embodiment, shown in FIG. 2. The left side view is the mirror image of this view.

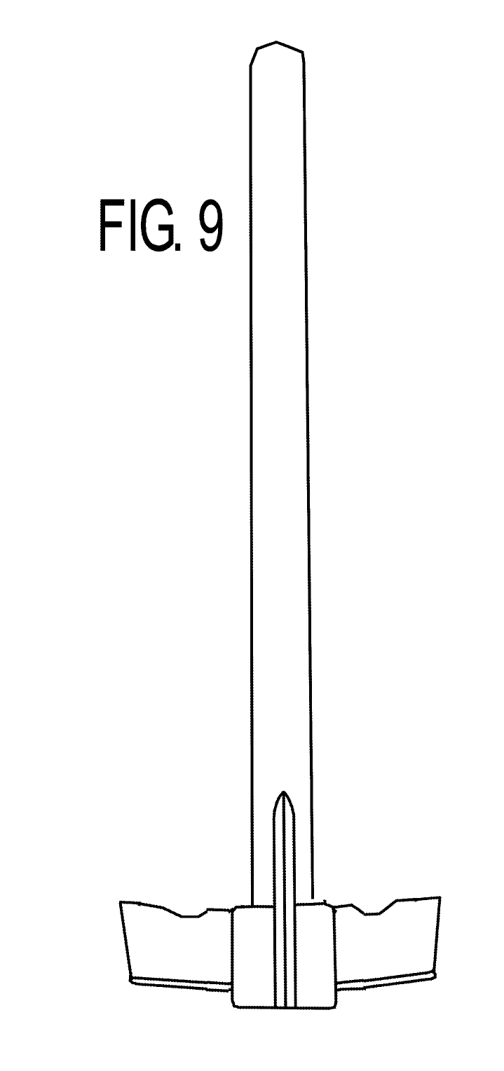

FIG. 9 shows a full-length back view of the first embodiment, shown in FIG. 2.

FIG. 10 shows a plan view, looking down the handle, of a second embodiment of the present invention.

FIG. 11 shows a right side view of the lower portion of the second embodiment, shown in FIG. 10. The left side view is the mirror image of this view.

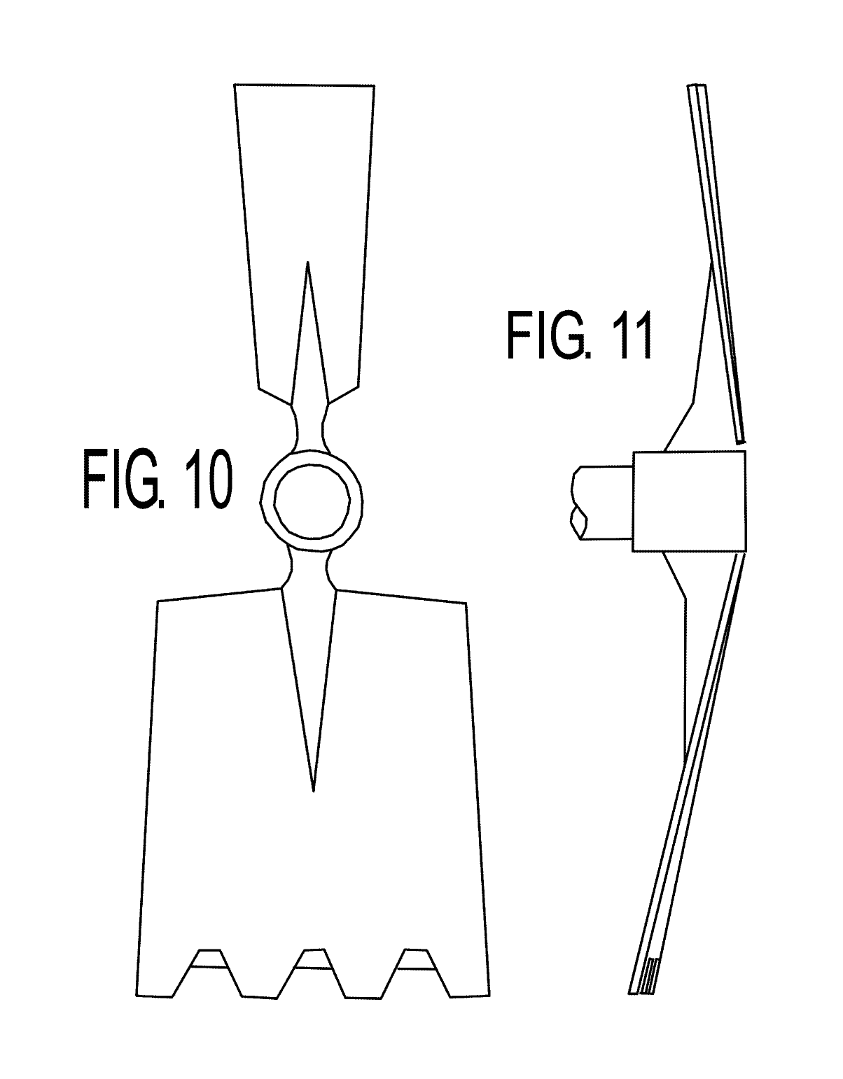

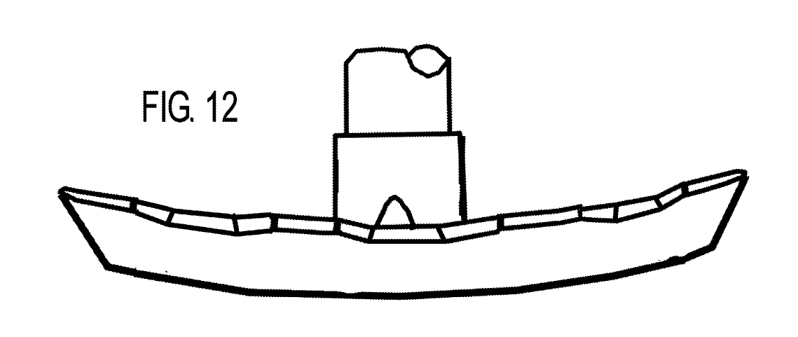

FIG. 12 shows a front view of the lower portion of the second embodiment, shown in FIG. 10.

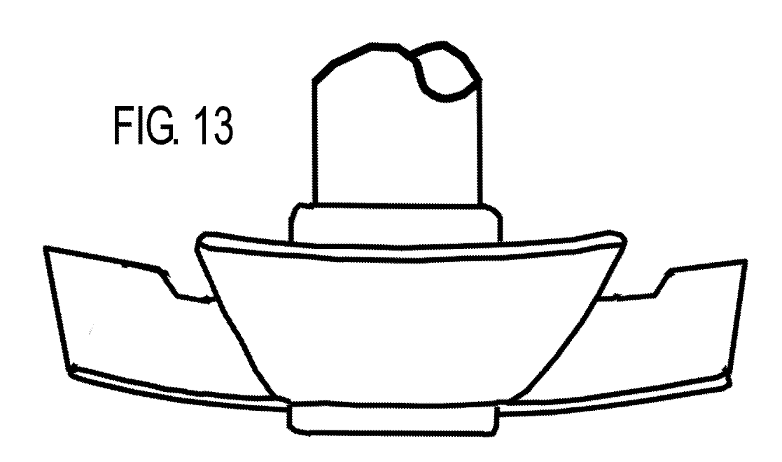

FIG. 13 shows a back view of the lower portion of the second embodiment, shown in FIG. 10.

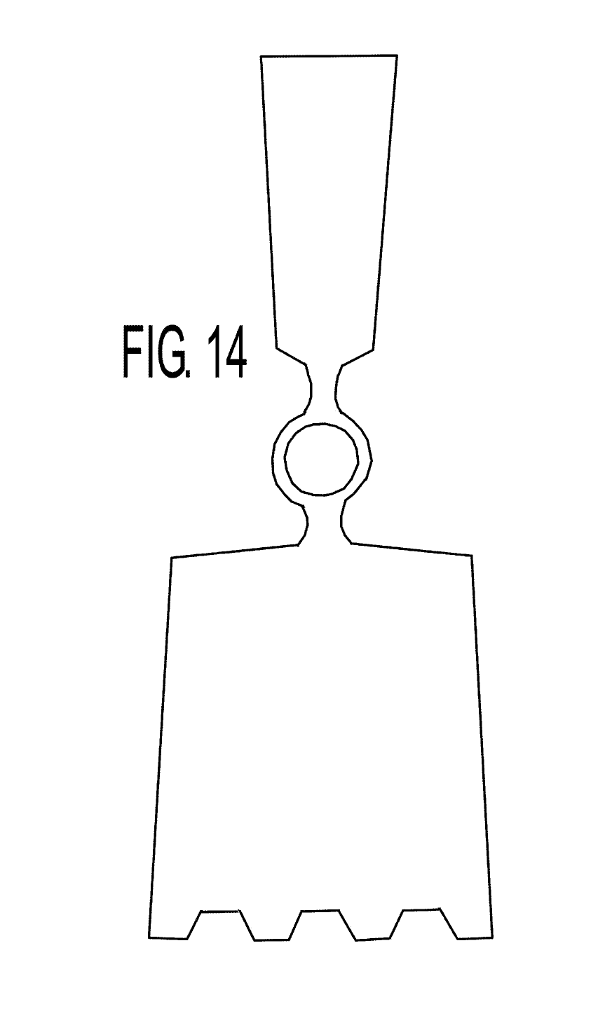

FIG. 14 shows a bottom view of the second embodiment, shown in FIG. 10.

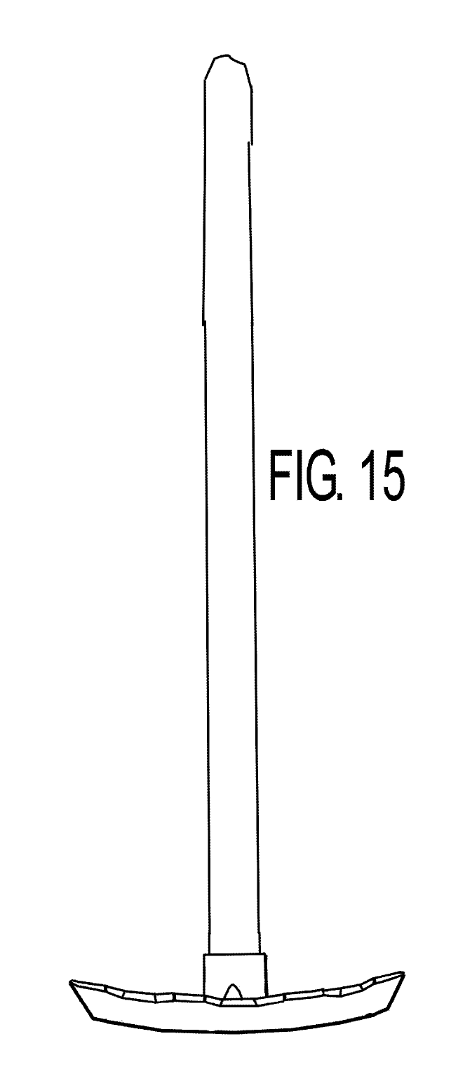

FIG. 15 shows a full-length front view of the second embodiment, shown in FIG. 10.

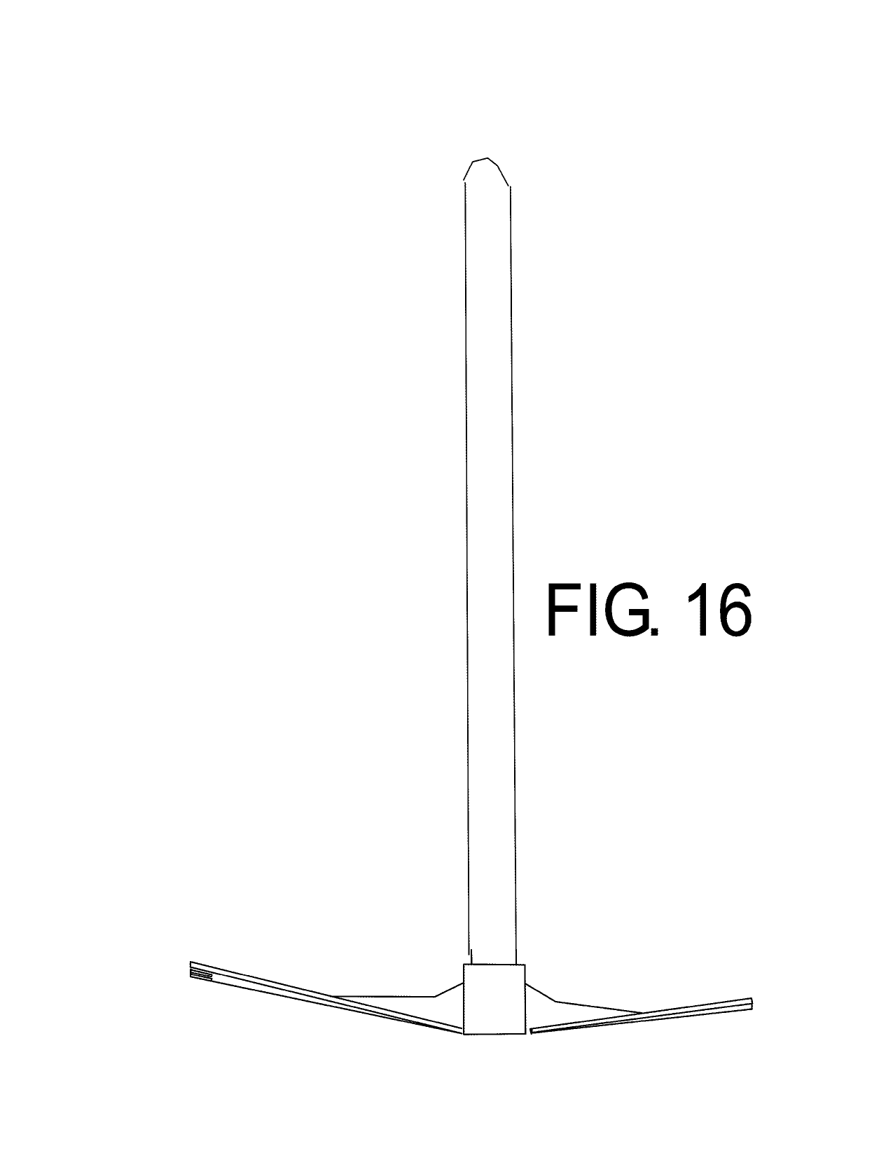

FIG. 16 shows a full-length right side view of the second embodiment, shown in FIG. 10. The left side view is the mirror image of this view.

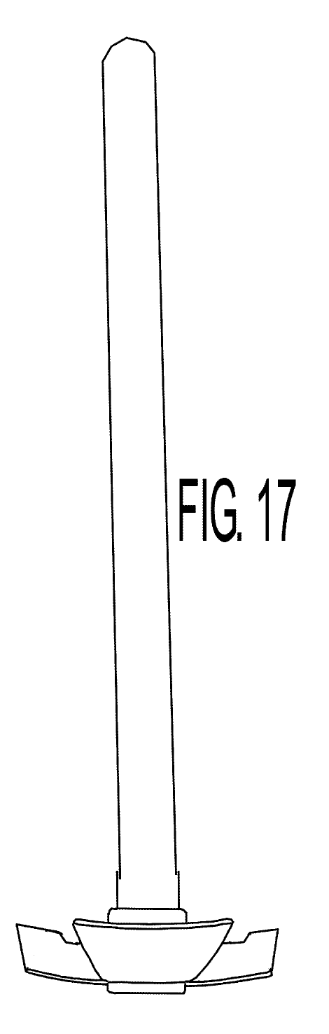

FIG. 17 shows a full-length back view of the second embodiment, shown in FIG. 10.

I have often felt, especially when my previous tools broke at the worst time, that I could design and build a tool far superior in every aspect for normal hand work and site conditions. A tool that would be very reliable, balanced in hand, strong but not too heavy, efficient and pleasing to the eye—where quality and good proportions would readily show. A tool that, even in the hands of a person with limited experience would yield sufficient results and feel good. A person of very little or no experience, such as some of my younger and older workers, would be able to learn how to use it efficiently in a very short time.

Over the last three or so years, I've dedicated a good deal of thought to the design of a site work tool that would stand on its own. A tool that under normal work conditions would last a lifetime and more. A tool that would have a high level of integrity in every detail. A tool that could be relied upon, time after time. A tool that could be used by a wide range of professional people, from small to large contractors, site workers, utility company workers, hardscapers, landscapers, forestry and agriculture workers. Also, regular homeowners for the garden and smaller scale work around the yard would find this tool very useful.

I finally got everything lined up and, within last year, built several prototypes, tested, refined, tested again under site conditions, and am very pleased with excellent results:

Hoe—The hoe is built around a strong tool handling—eye, 2″ deep and 1⅞″ O.D. schedule 80 pipe ( 3/16″ thickness) as a hub for the blade at the front and either a hammer or axe on the backside. This eye has a good purchase or grab on the wooden handle which substantially reduces fiber stress and improves leverage. The eye or handle ring is flared toward the bottom (⅛″) so that the handle can be fitted properly and will not slip out during usage. Alternately, the wood handle can be substituted with structural fiberglass or composite material which is also non-electrically conductive.

The eye connector to the blade(s) is a solid, structurally strong member (as shown in the drawing) and extends into the blade by at least ⅓ of its length. The blade thickness is either 3/16″ or 10 gauge. In both cases, the cutting edge has four teeth of the same thickness of the blade which are blunted, as shown, for the rigors of heavy duty work on rocky soils and sustained integrity. The actual sharper edge is set back from the leading edge teeth by ½″, the blade is also curved for extra strength (see drawing).

The axe, on the opposite end of the cutting edge is about 4″ in length (see drawing). This axe is 3/16″ thick and has two wings connected to the eye, for strength without extra weight.

During site prep work, roots are often in the way and must be removed. The great thing about the axe is its immediacy and convenience—by simply flipping this tool (hoe), this type of removal can be done without losing work momentum by constantly having to reach for another tool.

Alternately, in place of the axe, a hammer can be placed (built in) there for dressing up tough soil/clay or chipping off sharp edges on rock, as work progresses. All blades must be temper hardened (carburized) to the point where they are strong enough to maintain shape (flex and return to original shape) during stress work, yet not brittle, which increases the risk of breakage when a blow is struck on a hard surface, such as a large rock under the surface of the soil.

The blade, as sized, is perfect for all site work use. It can also dig a trench in one pass (very efficient) for laying pipe for drainage or utilities with minimal impact in residential projects, where often, access by a machine is limited or undesirable due to obstacles such as shrubs, planting beds, overhead clearance issues, fences, and other restrictions.

Landscapers can do many of their duties better using this tool (hoe) with much less effort and in a fraction of the time that it would take using other tools. I've personally planted many trees of different sizes, shrubs and flower beds over the years and this tool made the task much easier, much quicker and better. I would not even consider using any other tool alone for the purpose.

The lay of blades relative to the eye and therefore the handle (angle of departure from a straight line) is placed deliberately so that a wide range of people using the tool can work it without getting into awkward positions—it is comfortable to use.

GARDEN HOE—A scaled-down version of this tool is perfect for gardening (as shown in the blueprint). The blades are ⅛″ in thickness and the handle eye is 1½″ O.D. and 1¾″ deep. All the principles used in the construction of the full-sized model apply to this HOE also. On the opposite side of the main blade is a narrow blade which is perfect for weeding and quickly making a furrow for placing seed and placing small plants. The tool itself is very light so that almost anyone can handle it dexterously and feel a sense of accomplishment and surprising efficiency resulting in a good experience and the willingness to use it again.

Furthermore, many people, who work in other sedentary professions, look forward to and enjoy diversion in their daily routines by engaging in relatively small scale work around the yard, whether it be landscaping, hardscaping, or gardening, and derive benefit not only from their creativity with their own hands but also from the physical exercise—improving their physical and mental health.

One of the features that may be employed in connection with some of the embodiments of this invention might be called the “protected blade”. The most common use of this excavation tool would be to chop through hard-packed soil that includes both roots and stones of various sizes. Because the roots can be quite stringy and tough, it would be desirable to have a blade on the working edge of the hoe plate. This would allow the hoe to cut through the roots. The problem is that, when that concept is actually tried, the presence of stones in the soil quickly causes the blade to become dull and to lose its ability to cut through the roots.

This “protected blade” concept employs castellated teeth 36 at the working edge of the hoe plate 30. The back-set base edge between each tooth is sharpened into a cutting blade 37. The space between the teeth is flared outward between the blade 37 and the outer ends of the teeth 36, and about 30 degrees of the center line between the teeth, and thereby funnel roots between the teeth 36 and onto the blade 37.

FIG. 18 shows a perspective view of a small portion of the hoe plate 30, including two teeth 36 and the blade edge between the two teeth and set back from the forward edge of the two teeth.

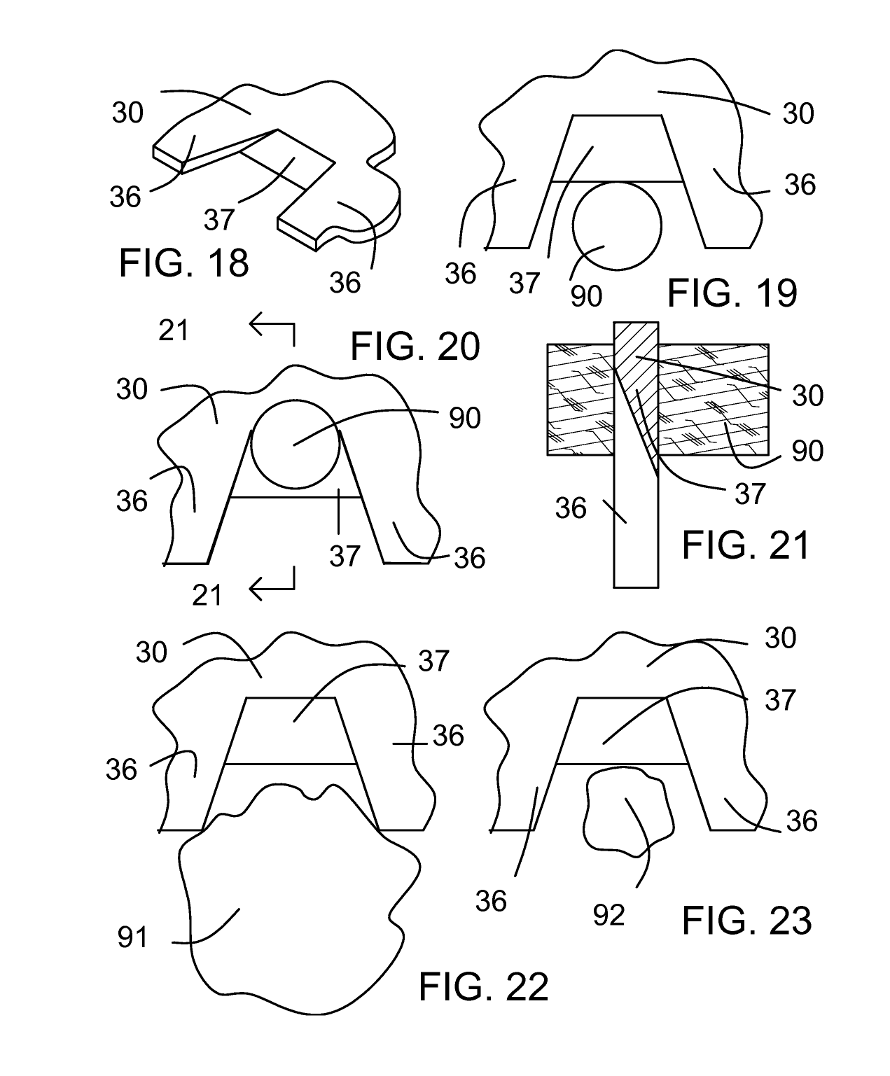

FIG. 19 shows a front elevation view of the hoe plate 30 portion shown in FIG. 18, and showing the blade 37 approaching a typical root 90 found in soil. The root 90 has passed freely between the two adjacent teeth 36, toward the blade 37.

FIG. 20 shows a front elevation view of the hoe plate 30 portion having cut through the root 90.

FIG. 21 shows a right elevation view, in section taken along line 21-21 of FIG. 20, showing the root 90 severed by the blade 37.

FIG. 22 shows the manner in which the adjacent teeth 36 protect the blade 37 from large stones 91 which are the primary mechanism by which the blade 37 is dulled.

FIG. 23 shows the manner in which the adjacent teeth 36 allow small stones 92 to approach the blade 37. It has been found that small stones 92 have minimal dulling effect on the blade 37. This appears to be because the small stones 92 have significantly smaller mass and inertia, and because they have a significantly reduced cross-section, so that the small stones tend to be pushed out of the way by the blade 37 rather than resisting the blades force and thereby dulling the blade edge.

The device includes a ground penetrating (soil/snow/ice)-blade with teeth to aid the effort. The device has a combination of blade size, thickness, weight and proportions, angle to working handle (toughness, hardness combined with long wear and shape retention). The device exist in combination with axe or narrower blade on the back side (180 degrees) of main working blade, all connected to a handle holding eye of good proportion to hold firm this line tools to its working handle with greatly reduced stress to wood fiber or composite material thereby assuring long and reliable life between these working parts, increasing reliability and integrity of tool function in a wide range from light to very heavy-duty demand on tool capabilities while performing manual labor

The scale range from the smaller to the larger blade is designed specifically to comfortably accommodate levels of experience and strength for the average person, men and women, to perform gainful and efficient results in productivity in a wide range of settings specific to individual or combinations of tasks, commonly found in most job sites

The combination of blade proportions and weight, which are an integral part of the design of these tools (along with toughness and hardness) allows for tremendous strike force, often required to penetrate a variety of tough soils ranging from hard-pan dry clay and rocky compacted soils to the severance of roots, often found at work sites, with precision and great control.

This precision and control in combination with momentum generated by one of the ways the tool works, is of absolute importance to the ability of the tool to impart the tremendous force required to deal with tough ground, hard snow/ice often found at the site.

The design of these tools allow for this kind of force to be used on a sustained basis, without compromising the integrity of the tool. This productive capability is made possible with greatly reduced effort on the part of the worker, compared to any other hand tool used for the same purpose.

BACKGROUND—BENEFITS: Thick, long, narrow common steel/iron spike or blade will penetrate typical ground but it is too heavy for sustained work by most people and then other tools must be used to dislodge and remove (such as shovels) the spoil pile.

This process is very tedious and requires a great deal of energy and time to do a relatively small amount of work. Often, roots and rocks are found as part of the ground being worked and even more tools are required such as pry-bars, axes, picks and rakes.

THERE'S A BETTER WAY: CAMELOT TOOLS BENEFITS: The size range on our blades is rlight in shape, length, width and thickness. The right type of steel is heat-treated and de-stressed to stabilize these blades for even the strongest and most skilled workers to use with confidence that they will not crack, bend, chip, or break.

Tools will flex, under heavy load, but return to original shape.

Light enough and balanced for anyone to perform real sustained work with control and precision with every stroke.

The same blade also cleans spoil pile spills, as you go, by using either straight side of the tool.

This benefit allows for real-time viewing and gauging the depth of the excavation, be it a footing for a wall or base preparation for a patio or a channel, with the right slope, for laying drain-pipe, etc.

The main working blade has “teeth” (cutting-edge) along a straight cutting plane to aid in ground penetration, which provides the all-important stability and control during contact with ground/ice.

This orientation continues to provide, maximum stability during the strike, even if the blade penetrates the ground at an angle, as is often the case. This is based on trial and experimentation with and optimization of the width-to-height relationship.

BACKGROUND: These hand tools were designed, built, tested and refined by someone with a strong technical background in Forestry, Farming, and Ecological Management of natural resources.

Decades of hands-on practical field experience in construction, site excavation and a great deal of study with focus on efficiency has contributed significantly to what really works.

We often find our work is needed in restricted spaces (where machinery and hydraulic equipment is not a practical option—next to fences or walls, near slopes or high ground, near shrubs, flower beds, mulched areas, near stairs, near underground pipes or utility lines) having to perform a variety of tasks ranging from hardscaping construction such as trenching and site preparation to all aspects of landscaping and delicate work around gardens and established lawns, etc, all using hand tools.

Before these tools, the process often was tedious, inefficient and time consuming, using any and all variety of those tools. Even with this arsenal of tools at our disposal, some of them were not up to the task and broke down along the way. The ones that held-up without breaking, were heavy, awkward to use and took a long time even to do a small amount of work.

Based on these and other experiences along with my science based, technical background, I knew that I could engineer, design, and build a set of hand tools which could simplify considerably all aspects of manual excavation. Also critical would be the usual understanding and expectations for sustained and efficient performance for a variety of tasks. To show real progress.

Today, for the first time, you have your manual, site-work and excavating tools that can greatly simplify your tasks around the yard or jobsite.

Everything about these tools is there on purpose for a wide range of tasks They can make it possible to take on projects which previously would be out of the question with hand tools. They are ideal for the purpose in their combination of parts, shapes, scale, weight, balance, and quality of materials that together define them as unique tools. They can be easily used by the “average” person—men and women—for extended periods of time, with reduced effort and greater efficiency.

You can also accomplish your excavation work with much less body stress on joints (back, shoulders, elbows, and wrists) based on how the tools work.

The tools are lightweight. They are easily controlled with precision over a wide range of tasks, including breaking tough ground such as hard-pan and rocky soils and roots.

They are built to perform heavy duty work with confidence that they will retain their integrity. They are hard and tough and will not lose form or shape.

Again, they really work for you and stand upright, conveniently.

If you're looking for the best, professional quality excavation hand-tools—these are for you.

FOR EXAMPLE: These tools can be used for yard/garden/nursery work; such as tilling soil, weed work-dandelions, crabgrass, etc (precision), planting seed beds correctly and quickly—the teeth open four furrows at a time, in line (right depth); drop seed, side edge of tool covers seed. Done! You acna also use the tool to plant, transplant—flowers, vegetables, etc., cut unwanted roots, quickly and efficiently, lay standard (white or black) drain pipe in one pass, lift and roll up sod neatly, replace sod, and lay up irrigation pipe extensions to new areas, cleanly with minimal site disturbance. You can also excavate the prepare wall, walkway and patio beds quickly and precisely, perform ground grading, excavation and trenching, perform precision edge work around flower and shrub beds, brush clearing, and many other tasks besides the ones listed here.

CONSTRUCTION/LANDSCAPE: These tools can be used for trenching/excavation, precise isolation of landscape features, wall, walkway, patio base excavation, site preparation, planting, transplanting, and uprooting, utility line excavation/exposure with precision and control, and work in any restricted space with precision. The tools are excellent for detail work, trail building, maintenance throughout the year, and erosion control throughout the year.

WINTER TIME: These tools can be used to break up/remove hard-packed snow/ice banks with very little effort, quickly open up drainage channels on hard ice during and after a rain storm, especially in late winter/early Spring, unclog storm drains of ice and debris, conduct watershed management throughout the year, including ice break-up, erosion control, and conduct trail maintenance and removal of dangerous obstacles such as ice build-up due to freeze/thaw cycles and upheaval of rocks and roots due to frost and frozen ground. No problem for this tool.

FORESTRY, AGRICULTURE, FIRE MANAGEMENT: These tools can be used for all wintertime applications that apply here. The tools are light, well balanced, strong and tough, easy to carry for long periods of time. The tools are perfect for re-Forestation: tree planting made easy with one strike, drop in tree behind blade, pull out blade, tuck with foot. Done. The tools easily open fire breaks. The wide blade stomps out small fires, and the same blade picks up soil/sand to smother smoldering ground fires. The axe improves access to tight spaces in smoldering roots and stumps to drop in soil, sand with wide blade to smother smoldering fires, deep inside.

These tools can also be used for erosion control, drainage/culvert work, beaver dam control, trail building/maintenance—all year, and brush clearing, irrigation, maintenance.

URBAN FIREFIGHTING: These tools are light, strong, tough, and dependable, can-do tool. Great weight distribution, balanced, with geat control and precision during use. They are tough enough to blow through brick, cement block, wood walls, wood floors, including planking, with measured control and speed.

DEMOLITION WORK in Connection with Building Renovations: This tool can simplify the task and save time in clearing interiors to the bare walls. You can do this faster and with greater control and precision, from a safer distance (compared to other conventional tools often used). Also, you don't have to spend half of the time and energy extricating other awkward and unbalanced tools from wall pockets where they often get stuck. The design and light weight of our tool is great for this job and keeps the workflow going with control—as a smooth and steady operation.

RESIDENTIAL CITY/TOWN: The tools work well in urban garden—all aspects of establishing maintenance and upkeep, and hard snow/ice management. If you reside in a northern city and park your car in the street or a tight spot and find your car in the morning “locked” in hard-packed snow and ice as a result of street plowing and temperature swings overnight, how do you extricate your car out of this jam? With one of our tools, you can solve your problem with precision and control, very quickly and easily, without expending a great deal of unnecessary energy.

This new excavation tool is the one to have anytime site work is expected. It is a light tool, with big output. I can be used for digging, trenching, scraping, and cutting. It is also useful for applications such as breaking up ice and hard-packed snow (very easy).

Other applications are tilling soil, all types of garden work, including planting (flowers, vegetables, trees); sowing (seed beds); weeding. Also trail building and maintenance throughout the year, site preparation for walkways, patios, wall beds, and excavating and tampering soils. The tool can be use as a hammer to drive pins/stakes in the ground.

The tool allows neat and quick separation of a line where organic soil/sod is to be removed from a site for hardscape construction, leaving the rest of the grass area or ground undisturbed. This is also true for mulch areas with a clean separation from grass areas.

This tool allows the digging of a trench wide enough in one pass for laying pipe (4-6 inch diameter) with minimal or no disturbance to surrounding ground. This same tool can cover the trench, with pipe in place, with ease and extreme efficiency. Same is true for the variation which has the long, narrow blade in opening a channel to lay sprinkler pipe.

The tool allows sod removal, neat peels and rolls easily, so that sod can be re-used back in the same work area. The tool is useful for final excavation around utility lines, as required by appropriate codes. Proportions are designed for maximum control for delicate excavation and exposure. The tool is useful for utility work, storm drains, soil drainage, and septic tank cover exposure

This tool can be used for remote firefighting, clearing edge rows/fire line breaks, subduing live embers and smothering smoldering roots, etc. This tool can be used for Agriculture, including nurseries, planting and transplanting. This tool can be used for forestry; tree planting, erosion control, utility work, and beaver dam control. This tool can be used for local municipalities, channeling/trenching; and wintertime fire hydrant exposure. This tool can be used for military construction, battalions, Seabees, site work, FOBs, and expeditions (tropical to arctic). This tool can be used for City/Urban areas; city areas where often cars, closely parked in tight spaces, need to be extricated from hard snow and ice or narrow alleys to regain passage. Using any other hand tool, including shovels, is more awkward, takes much longer and requires much more exertion.

This tool is unique. It is extremely versatile. It performs a wide range of tasks in a wide range of settings, very efficiently, resulting in high-efficiency precision work.

There are four primary variations of the same tool: a) construction version with axe on back side, b) landscape version with long narrow blade on back side, c) garden version, scaled down—with long narrow blade on back side, and d) garden version, scaled down with axe on back side.

Features of the tool: The tool has ergonomic blade size with optimal working shape. The tool has axe blade for cutting roots often found in worksites, with no loss of work momentum, eliminating the need to reach for separate axe. The tool has a light blade that does big work. Tool stands upright, conveniently. The tool is a well-proportioned and balanced tool with strong connections between working parts, and well connected to the handle over a wide area to minimize fiber stress (on a wooden handle) or a generous grab on a composite handle. This functions to minimize the possibility of handle breakage or separation at the most inopportune time. The tool retains integrity, ready for work, under all usual handwork load conditions long wear, will not lose its shape with excellent balance between hardness and toughness.

Benefits: The tool is extremely efficient, with small exertion, and large output. The tool is easy on joints, elbows, shoulders, wrists, and back. The tool uses tool momentum to break ground. The tool allows pull motion using body mass, lean back to dislodge load, and set the tool aside. The tool allows easy lifting of the load, intact, and easy setting of the load aside, out of the way. The tool allows work for prolonged stretches of time without getting tired (less exertion), compared to other hand tools, while showing efficient results and progress. The tool is easy to learn how to use, even for those with little or no experience; younger, older, men and women. The tool easily accesses tight spaces where range of motion is very restricted.

The essence of the tools of the present invention is Strength, Proportions, and the all-important Lightness of Weight.

In designing these tools, my objective, based on experience, was always to make the tools as light in weight and as strong as possible, as my original prototypes show.

For example, during development, I chose mild steel plate (for R & D) ranging from 3/16″ (¼″ for axe) for the blades all the way down to ⅛″ for the smaller versions.

We originally selected a blade thickness of 3/16″ for the larger versions with ribs on the back axe (¼″ or 3/16″ in thickness).

The smaller version preferably has ⅛″ in thickness.

The teeth also were made deeper and wider in their current form, from the originals.

Further metallurgical research on strength, toughness, and heat treatment options (hardness) prompted the following adaptations to my original prototypes:

We could reduce all blade thickness to 10 Gauge (0.1345″) throughout with 3/16″ (0.1875) for eye and axe on all variations, with excellent performance results and tool weight results. No need for reinforcing “ribs” on axe.

The smaller version weighs about 2 lbs., and 3 lbs. with a full length 42″ ash wood handle. The larger version weighs about 2¾ lbs., and 4½ lbs. complete with 42″ ash wood handle.

This lightness in weight combined with its strength and toughness, by far, separates these tools from all of the prior products. It makes them unique and very desirable on all accounts.

A typical prior art tool has head dimensions of 13″×5.5″, a 4″ wide pick (axe), and weighs 6 lbs. The dimensions of this tool are about the same as my smaller version garden hoe, except that my tool weighs 2 lbs. (without the handle) and 3 lbs. with a 42″ ash wood handle. Thus, the prior product (6 lbs.) weighs more than 2 times the weight of my full-size construction version (2¾ lbs.).

LIGHT AND STRONG: In our line of work, we excavate in a variety of settings, with hand tools, and different levels of difficulty in ground penetration. We need a very strong tool capable of great striking force (without losing structural integrity) in order to perform more difficult tasks efficiently. Based on field experience, weight and balance are a major concern and no one can perform sustained and efficient work with a heavy hand tool on a regular basis and just as important, no one wants to, given a choice.

The objective: To eliminate excessive tool weight, improve balance and multiply performance, by designing, building and testing two versions of a manual excavation tool, as light in weight as possible, with teeth on the leading edge, of the main working blade, to aid in tough ground penetration. This main blade should be between 50 and 60 square inches of working area for sustained work for tradespeople. The reduced scale, Backyard/Garden version, shows good balance and proportion with the main blade between 30 and 40 square inches. Furthermore, the integrity of these tools should be such that they might behave like spring-steel under heavy load, but without brittleness, commonly associated with it.

The next step was to find a good choice of steel that could be heat-treated to produce a good balance between hardness and toughness and found that there are several types that would be well suited for the purpose. We settled on medium carbon steel, which is well suited for the purpose, in a range between 0.4 and 0.5 of 1% carbon (1040-1050).

We were then able to heat treat the tool prototypes for hardness, on the Rockwell (HRC) scale, to values between 35 and 45 and field-tested the results. In this range, the samples were all tough and very strong. However, the higher values showed less deformation with no bending, cracking, chipping or breaking, under extreme load and abuse.

This heat treatment method is designed to provide a strong and hard (eggshell-like) outer layer with a relatively soft inner core in the middle (Austinatize, Quench and Temper to HRC 38-45), to provide long wear, hardness and toughness. This also prevents shattering of the blade upon strong impact with a hard surface, such as a rock hidden under the surface of the soil, etc.

Prior excavation hand striking tools are thick and have narrow working blades They are too heavy for sustained work and are not balanced nor efficient. Many more strikes are needed, more time and much more energy are used, to do the same work, compared to the size, weight, configuration, combination of parts and proportions (scale) and balance of hand tools of the present invention.

Our tools can multiply your power and strength and allow you to do what you want very efficiently by being light in weight, tough and strong.

The Professional versions (larger) weigh around 2 and ¾ lbs., and, complete with a 42″ ash handle, around 4½ lbs., each.

The Backyard/Garden versions (smaller) weigh around 2 lbs., and, complete with a 42″ ash handle, around 3 lbs., each.

CAMELOT TOOLS—FIELD TEST—BACK YARD GARDEN EXPERIMENT

Conditions: Dry, average organic soil
Prototype Tool (⅕) larger version—EXCALIBUR
Tool weight, with 43″ wooden handle: 4¼ lbs.
Empty Bucket: 2¼ lbs.
Bury tool to eye in soil and lift load into bucket without spills (as is). Only what the blade could carry on its own in one lift.

### Total Load

Net Load+Tool=Total Load

8.25 lbs.+4.25=12.5 lbs (i)

6.75 lbs.+4.25=11.0 lbs. (ii)

8.25 lbs.+4.25=12.5 lbs. (iii)

36.0/3=12 lbs. Total Average Load

If the tool was of similar shape and weighed one or two pounds more, then, the total average load of the soil pile would increase to 13 or 14 pounds. Now, repeat this over the course of a day's work.

Today, most tools for excavation are much heavier in weight and half as wide for a working surface area which translates into a much smaller displacement of soil (little work for a lot of effort).

Those prior tools that are wider, are much heavier. In both cases, the tool's heaviness may have to do with lack of significant field experience on what it takes to get the job done, but also, it may have to do with a lack of innovation in the design of prior tools.

Those prior tools that recognize the importance of strength, sacrifice the all important working surface area by increasing thickness and reducing the width of the tool, to reduce tool weight. This reduces these tools to little more than a pick.

When a worker has to displace soil, such work is often required in most site working projects and this work often has to be performed manually. On an average day of 8 hours, this worker will end up lifting several thousand pounds more than a person with a similar tool that weighs one pound less than the heavier tool.

For example: In an 8 hour day, involving 4 hours of actual work, the weight of the tool matters.

Analyzing the extra work that the worker must do,

(1 lb.)×20 strikes/minute(60 minutes/hour)(4 hours)=4,800 lbs. more

(1 lb.)×30 strikes/minute(60 minutes/hour)(4 hours)=7,200 lbs. more

This extra work occurs if the tool weighs only one pound more than the lighter tool, that can be created using concepts of the present invention.

In reality, the person with the heavier tool will likely reduce frequency to fewer strikes per minute and thereby, reducing performance, and extending the time required to do the work.

If the prior, heavy tool weighs 1½ lbs. more than the tool incorporating the design of the present invention, the worker will likely reduce frequency even more, resulting even lower performance and production.

Analyzing the extra work that the worker must do,

(1.5 lbs.)×20 strikes/minute(60 minutes/hour)(4 hours)=7,200 lbs.

(1.5 lbs.)×30 strikes/minute(60 minutes/hour)(4 hours)=10,800 lbs.

Extra weight handled by a worker with a heavier tool over the span of one day's work, is both more exhausting, and less productive.

If the tool is even heavier and narrower to improve the all important tool strength, it would not be suitable for sustained work, and its performance would br even worse.

This effort and production factor is one of the reasons why the light and strong aspect of the manual, ground penetrating, excavation tool of the present invention is so important, especially its weight, geometric proportions, and surface working area. This allows the worker to maximize efficiency and production with greatly reduced effort.

An example of a tool we consider optimum has a working plate of 42 square inches, with a width at the inner edge of 6.25 inches and an outer edge of 7.25 inches. The height, from the outer edge of the eye, is 7.5 inches. Thus the height to average width ratio is 1.1, that is, the height is only slightly greater that the average width.

The numbers set out in this disclosure represent what we consider the optimum values. However the benefits of this invention are not limited to the specific values. Rather it appears that some of the benefits of this invention are present within plus or minus 15% of the optimum values. The preferred range is plus or minus 10%, and the optimum range is plus or minus 5%.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A hoe-like excavation tool, comprising:
a. an elongated handle,
b. a hoe plate mounted to one end of the handle, perpendicular to the handle and offset from the axis of the handle, and
wherein the plate has a sharp working edge, and a plurality of teeth extending outward from the edge.
